(19) United States
(12) Patent Application Publication
(10) Pub. No.: US 2008/0289436 A1
(43) Pub. Date: Nov. 27, 2008

(54) Measuring Apparatus in Connection with a Gear

(75) Inventor: Pekka Laakkonen, Helsinki (FI)

Correspondence Address: WOLF, BLOCK, SHORR AND SOLIS-COHEN LLP, 250 PARK AVENUE, 10TH FLOOR, NEW YORK, NY, 10177, US

(73) Assignee: Moventas Oy, Jyvaskyla (FI)

(21) Appl. No.: 11/571,799

(22) PCT Filed: Jul. 1, 2005
(86) PCT No.: PCT/FI05/50266

§ 371 Date: Jan. 8, 2007

(30) Foreign Application Priority Data
Jul. 15, 2004 (FI) 20040989

(51) Int. Cl. G01L 5/12

(52) U.S. Cl. 73/862.49

(57) ABSTRACT

The invention relates to a measuring apparatus (200) in connection with a gear (10). The gear comprises at least one first shaft (11) and at least one second shaft (14), a gear wheel placed on the first shaft (11) and comprising a helical toothing, which gear wheel (12) cooperates with a gear wheel (13) provided with a helical toothing and located on the second shaft (14). The gear (10) comprises in its connection the measuring apparatus (200), by means of which the axial force transmitted to the shaft (11) can be measured. The measuring apparatus (200) for measuring axial force comprises a bearing (17) located in connection with the shaft (11) in the gear, which bearing receives the axial forces. The axial force is transmitted further via the bearing (17). The device arrangement comprises a rod (20) to which the axial force is transmitted from the bearing (17), the rod (20) being located between the bearing (17) receiving the axial forces and the housing (100) of the gear. The device arrangement comprises a sensor (25), which observes the axial force applied to the rod (20).

The invention relates to a measuring apparatus in connection with a gear.

This invention relates to the measurement of the magnitude and direction of the axial force of a shaft in a helical gear set. An industrial gear set is used for changing the speed of rotation and the torque of a driving device, for example, an electric motor, so that they are suitable for a machine to be driven. The change is carried out using at least one pair of gear wheels connected to shafts. The structure of the gear becomes more advantageous when it is possible to use helical gear wheels. The helical teeth cause that axial forces are produced in the gear shafts. To determine the service life and the maintenance interval of the gear, it is also good to know the axial force that is transmitted.

An arrangement is known in which a shaft-mounted gear has been mounted on the shaft of a machine to be driven. To keep the gear in place, it must be fixed to a body by means of a support. Force can be measured using a measuring device, for example, a strain gauge fitted to a pin of the support. A drawback of this method is that it is suitable only for a shaft-mounted gear.

It is known that a measuring device is fitted between a motor and a gear. This kind of measuring device includes a measuring shaft to which a measuring element has been attached. The measurement result is transmitted to a surrounding non-rotating outer shell. Drawbacks of this measurement method are the lengthening of the construction, additional couplings, and wear of slide rings driven in continuous use. This measuring device is also difficult to retrofit.

It is also known that axial force is measured with a sensor that receives only compressive force. A drawback of this measurement is that it is possible to measure only one force direction with one sensor. If the shaft is a so-called output shaft, a second sensor cannot be placed at the other end of the shaft.

This application discloses a novel type of measuring apparatus in connection with a gear. The measuring apparatus is constructed inside a gear housing. In accordance with the invention, the axial forces F₁ or F₂ produced when helical gear wheels of the gear are in contact are measured from an end of a shaft. The invention uses at least one first bearings on the shaft, which receive the radial forces produced when the gear wheels are in tooth contact, and the invention uses at least one second bearing, which receives the axial forces produced when the gear wheels are in tooth contact. The invention uses a rod placed between said bearing receiving axial forces and the gear housing, to which rod the axial forces are transmitted as pure from the axial bearing. In the structure in accordance with the invention, axial forces are advantageously transferred from the shaft via a sleeve to the bearing that receives the axial forces, and further via its rolling members, such as balls, to an inner bearing race and therefrom to an end piece to which the rod has been attached. The rod and the end piece are not rotating. The end piece is situated inside the sleeve placed at the end of the shaft. The rod is articulated with the end piece and the other end of the rod is connected either via a second end piece to the gear housing or directly to the gear housing, for example, to its end cover. A sensor is placed either directly on the surface of the rod or in the end piece associated with the gear housing, for instance, in its bore. The longitudinal axis of the rod is advantageously parallel to the axis of the shaft of the gear, and advantageously in the same line or in its vicinity. By articulating the rod with the associated structures, detrimental bending moments are prevented from being produced and the axial force is transmitted as pure as possible to the sensor. The device arrangement makes it possible that the same sensor observes axial forces F₁ or F₂, i.e. axial forces opposite to each other.

The device arrangement in accordance with the invention makes it possible to measure the magnitude of the axial force, i.e. its absolute value, and additionally the direction of said axial force, i.e. the sensor observes the direction of rotation of the shaft and the direction of the thus produced axial force. In a braking situation, the direction of rotation remains the same but the direction of the axial force changes. In other words, the same device makes it possible to observe from the end of the shaft the axial force caused in the shaft of the gear by loading when the gear wheels are in contact. The sensor is connected further to a central unit 50, in which measurement information can be processed further. The central unit 50 transmits information about the axial force during operation of the gear and information about its direction further to the operator.

The measuring apparatus in connection with a gear according to the invention is characterized by what is stated in the claims.

In the following, the invention will be described with reference to some advantageous embodiments of the invention shown in the figures of the appended drawings, but the invention is not meant to be exclusively limited to said embodiments.

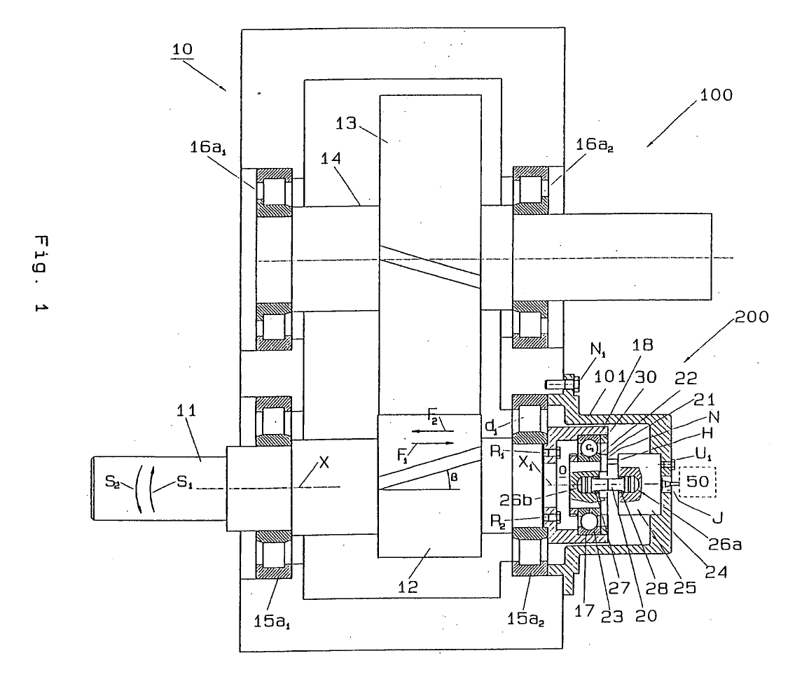

FIG. 1 shows a first advantageous embodiment of the measuring apparatus in accordance with the invention. The gear is shown in longitudinal cross-section.

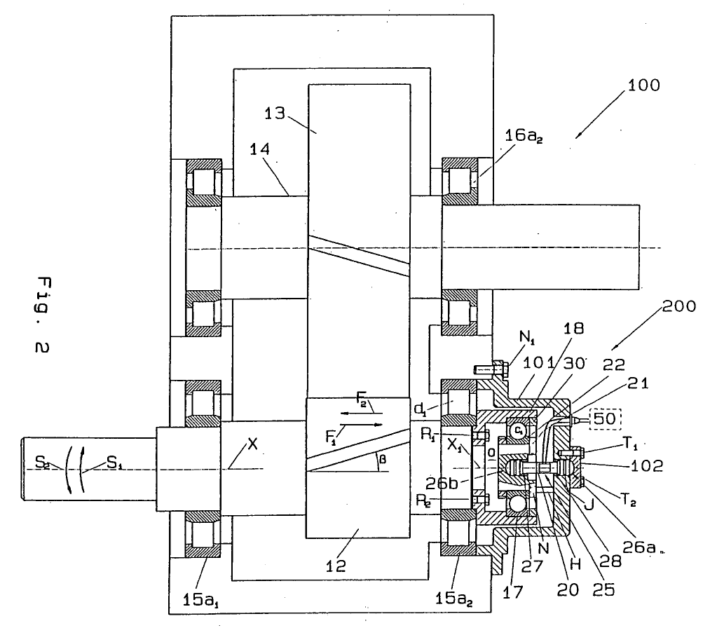

FIG. 2 shows a second advantageous embodiment of the apparatus in accordance with the invention, in which embodiment a measuring sensor is connected directly to a rod and the rod is connected to a gear housing, for example, to its end cover.

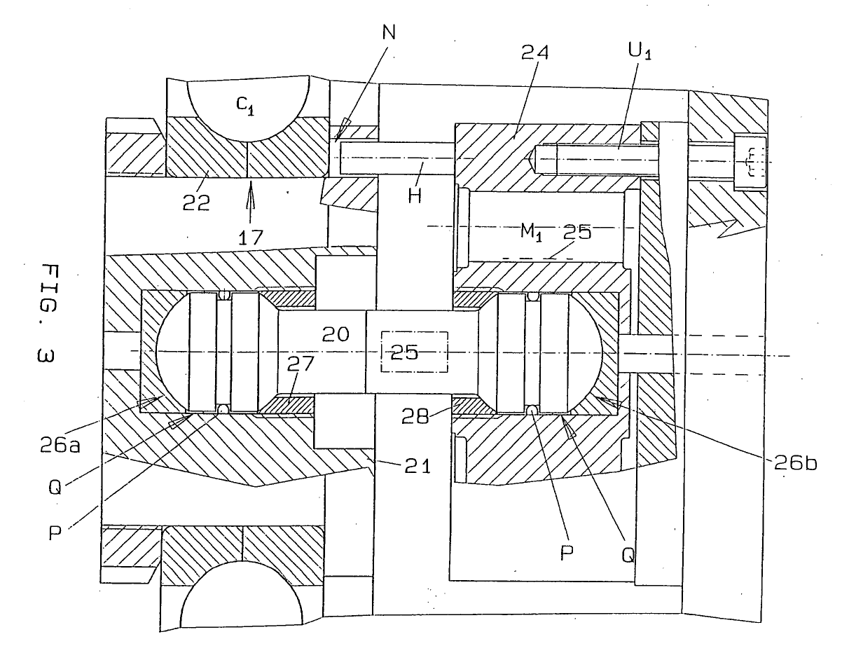

FIG. 3 is a separate illustration of the rod in connection with its end pieces.

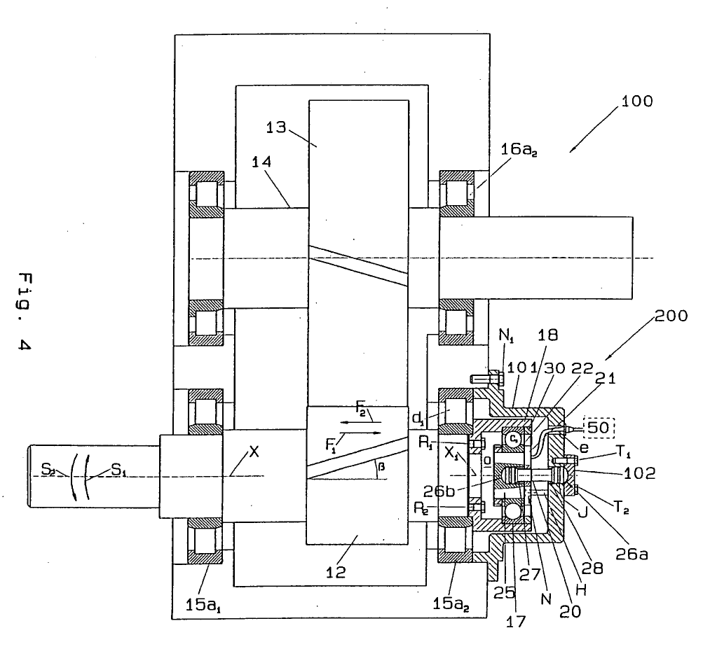

FIG. 4 shows an alternative location for the sensor in a first end piece associated with the rod.

FIG. 1 shows a gear 10 which comprises at least one first shaft 11 and a gear wheel 12 on it, and a second gear wheel 13 functionally connected to said gear wheel 12 and a second shaft 14 in the second gear wheel. In the device arrangement in accordance with the invention, the gear wheels 12 and 13 of the gear comprise helical toothing. The helix angle is denoted with β in the figure. The gear 10 comprises bearings 15a₁, 15a₂ on the first shaft 11 and bearings 16a₁, 16a₂ on the second shaft 14. A measuring apparatus 200 for measuring axial force and for identifying its direction is formed of a device arrangement provided inside a gear housing 100 of the gear 10, which device arrangement includes, among other things, a sensor 25, a rod 20 and a bearing 17 that receives the axial force. It is advantageous for the measuring apparatus 200 measuring the axial force F₁ or F₂ in accordance with the invention that the bearings 15a₁ and 15a₂ are roller bearings, advantageously cylinder roller bearings, which receive the radial forces produced when the gear wheels 12 and 13 are in gear contact but allow axial motion and transmit it to the bearing 17. Rolling members d₁, d₂ . . . are, for example, cylinder rollers. They do not receive the axial force F₁ or F₂. In addition to the bearings 15a₁, 15a₂ receiving the radial forces, the apparatus thus comprises the bearing 17 which receives the axial forces and which is connected to the end of the first shaft 11, preferably to its end piece, i.e. a sleeve 18. The sleeve 18 is a short shaft-like part, which is fixed to the end of the shaft 11 with attachment means, preferably with screws R₁, R₂ . . . . An embodiment is also feasible in which there is no separate sleeve 18, but a part of a similar shape is made as one piece with the shaft 11. The rod 20 is located between the bearing 17 and the housing of the gear. An end piece 21 associated with one end of the rod 20 is placed in an inner space O of the sleeve 18. An inner bearing race 22 of the bearing 17 is associated with the end piece 21. The bearing 17 is attached to the sleeve 18 by means of an attachment part 30. In the device arrangement, the end piece 21 and the rod 20 do not rotate. The outer bearing race of the axial bearing 17, i.e. an outer bearing race 23, is attached to the inner surface of the sleeve 18. The bearing 17 is advantageously a ball bearing that receives the axial force F₁ or F₂ transmitted from the shaft 11 and transmits it via the end piece 21 to the rod 20.

The rolling members of the bearing 17 are advantageously spherical balls c₁, c₂ . . . having a certain diameter. It is essential that the bearing 17 transmit axial forces. In that connection, the rolling members can also comprise an arrangement in which there are two bearing rings with conical roller bearings in them. The rod 20 is connected at its outer end to a second end piece 24, which is further fixedly attached to the housing 100 of the gear. The longitudinal and centre axis X₁ of the rod 20 is in the centre line, i.e. in the longitudinal axis X of the shaft 11 of the gear 10 or in its vicinity. The axes X and X₁ extend substantially parallel to each other. However, small inclination can be allowed. The rod 20 is articulated at its both ends by means of articulated joints 26a and 26b with structures associated with said ends, such as, the end pieces 21 and 24. The axial forces in the directions F₁ or F₂ are thus transmitted from the shaft 11 to the sleeve 18 and further to the bearing 17 and via it to the end piece 21 of the rod 20 and further to the rod 20. The other end of the rod 20 is located in the other end piece 24 placed in the gear 100, such as, its cover 101. The rod 20 itself does not rotate but it is allowed to be articulated at its both ends with the parts associated with the ends, such as, with the end pieces 21 and 24 described above. The rod 20 is connected to the end piece 21 by means of an attachment part 27 and to the end piece 24 by means of an attachment part 28. In the device arrangement, both the magnitude of the axial force and the direction of the axial force are observed/measured. In that connection, the rod 20 receives both tensile force and compressive force depending on the direction of the axial force. The articulating joint allows the axial force F₁ or F₂ to be transmitted as pure from the bearing 17 to the rod 20, and no bending moments are produced at the joint. In the embodiment of FIG. 1, the second end piece 24 comprises a sensor 25, preferably a strain gauge, which observes the effect of the axial force F₁ or the effect of the axial force F₂ caused to the rod 20 and transmitted by it, and in which connection information on strain is transferred via a line/lines e passed from the sensor 25 and transmitting measurement data, further to a central unit 50, where said measurement data can be processed and converted further into information about axial force and into information about the direction of the axial force F₁ or F₂. In this way, the axial force F₁ or F₂ is readable during the operation of the gear 10 independently of the direction of operation of the gear set. The measuring sensor 25 is preferably a strain gauge. Other sensors can also be used. In the embodiments 1 and 2, the end cover 101 of the gear housing 100 is attached with screws N₁ to the rest of the housing frame. The end piece 24 is attached with screws U₁, U₂ . . . to the cover 101 of the gear housing 100. Measurement information from the sensor 25 is passed to the central unit 50 via a line and an opening J in the end cover 101.

In FIG. 1, when the shaft 11 is rotated in the direction S₁, an axial force is generated in the direction F₁, and when the shaft is rotated in the direction S₂, an axial force is generated in the direction F₂ while rotating the shaft 11. The shaft 11 of the gear set associated with the measuring apparatus must allow a little movement in the axial direction.

FIG. 2 shows an embodiment of the invention in which the sensor 25, preferably a strain gauge, is located directly in the rod 20. The embodiment of FIG. 2 otherwise corresponds to the embodiment of FIG. 1. One end of the rod 20 is connected to the housing 100 of the gear 10 and to its end cover 101 comprising a through-opening J and a cover 102 closing it. The cover 102 can be opened with screws T₁, T₂. The end cover 101 is attached with screws N₁, N₂ . . . to the rest of the gear housing 100. In the embodiment of FIG. 2, a locking part 28 locks the rod 20 at its end to the end cover 101 of the housing 100. The other end of the rod 20 is attached, as in the embodiment of FIG. 1, to the end piece 21 by means of an attachment part 27. The inner bearing race 22 of the bearing 17 receiving the axial forces, is connected to the end piece 21. The outer bearing race 23 of the axial bearing 17 is connected to the sleeve 18, which is further connected to the end of the shaft 11, as in the embodiment of FIG. 1, with screws R₁, R₂ . . . .

The end piece 21 in the structure in accordance with the invention is thus placed in a given axial position with respect to the bearing 17, which receives the axial forces, and the sleeve 18. The axial force is transmitted from the shaft 11 to the sleeve 18, further to the outer bearing race 23, further via the bearing balls c₁, c₂ . . . to the inner bearing race 22 and further via it to the end piece 21 and further via it to the rod 20. The rod 20 is articulated by means of an articulated joint 26a, as in the embodiment of FIG. 1, with the end piece 21, and its other end is articulated by means of an articulated joint 26b with the housing 100, with its end cover 101. The articulated joints 26a and 26b make it possible that no harmful bending moments are produced, but, instead, the axial force F₁ or F₂ is transmitted as pure to the rod 20.

FIG. 3 shows how the rod 20 is connected to the end pieces 21 and 24. In the embodiment of the figure, the end piece 24 is attached with screws U₁, U₂ . . . further to the housing 100. As shown in FIG. 3, the sensor 25 can be located in the end piece 24 in a bore M₁ shown in the figure. This makes it possible for the force F₁ or F₂ to be transmitted from the rod 20 further to the sensor 25. The force F₁ or F₂ is received, as shown in FIG. 3, by the edge areas of the end piece 24, at which the end piece 24 is attached to the end cover 101 of the gear housing 100. In the embodiment of the figure, the sensor 25 (with lines of dots and dashes) can also be located in the rod 20, for example, on its surface. A rotation-blocking pin H located in a recess N of the end piece 21 prevents the end piece 21 from rotating, but since axial shift with clearance is allowed between the pin H and the recess N, the structure does not disturb the transfer of the axial forces to the rod 20. The pin H is attached at its one end to one end piece, in the embodiment of the figures, to the end piece 24. The rotation-blocking pin H also guides the end piece 24 to a correct position in the gear structure. The pin H prevents the end piece 21 from rotating with the shaft 11 due to the effect of the friction caused by the bearing 17. A resilient ring P in an annular groove of the rod 20 centres the rod 20 in a bore Q of the end piece 21/24. The rod 20 can be formed of two parts joined to each other by a threaded joint. By this means, the attachment parts 27 and 28 can be placed around the rod 20, diameters of the ends of the rod 20 being larger than that of the middle part.

FIG. 4 also shows an embodiment in which a sensor is located in a bore of the first end piece 21. In other respects, the embodiment corresponds to the embodiment of FIG. 2.

The embodiments described above represent a single stage gear, in which the shaft 11 is a power input shaft and the shaft 12 is the shaft from which power and drive are transferred to the device to be driven. The measuring apparatus can be located on either shaft. The device arrangement can also be used in connection with a multiple stage gear, in which case the measurement apparatus can be located on any gear shaft.

1. A measuring apparatus (200) in connection with a gear (10), which gear comprises at least one first shaft (11) and at least one second shaft (14), a gear wheel (12) located on the first shaft (11) and comprising a helical toothing, which gear wheel (12) cooperates with a gear wheel (13) provided with a helical toothing and located on the second shaft (14), and which gear (10) comprises in its connection the measuring apparatus (200), by means of which the axial force transmitted to the shaft (11) can be measured, wherein the measuring apparatus (200) for measuring the axial force comprises a bearing (17) located in connection with the shaft (11) in the gear, which bearing receives the axial forces and via which bearing (17) the axial force is transmitted further, and that there is a rod (20) to which the axial force is transmitted from the bearing (17), the rod (20) being located between the bearing (17) receiving the axial forces and the housing (100) of the gear, and that there is a sensor (25) which observes the axial force applied to the rod (20).

2. A measuring apparatus as claimed in claim 1, wherein the apparatus arrangement is such that the direction of the axial force (F₁ or F₂) is also observed in addition to the magnitude of the axial force (F₁ or F₂), and that the rod (20) receives both tensile force and compressive force depending on the direction of the axial force.

3. A measuring apparatus as claimed in claim 1, wherein an end piece (21) of one end of the rod (20) is disposed in an internal sleeve (18), so that the bearing (17) which receives the axial forces and transmits them further is between the sleeve (18) and the end piece (21), an inner bearing race (22) of the bearing being attached to one end piece (21) of the rod and an outer bearing race (23) of the bearing (17) is attached to the inner surface of the sleeve (18).

4. A measuring apparatus as claimed in claim 1, wherein the rod (20) is articulated at its both ends by means of articulated joints (26a, 26b) with structures associated with the rod.

5. A measuring apparatus as claimed in claim 1, wherein the sleeve (18), on the inner surface of which the bearing (17) receiving the axial forces is located, is attached with attachment means, such as screws (R₁, R₂), to an end of the shaft (11).

6. A measuring apparatus as claimed in claim 1, wherein the bearing (17) receiving the axial forces is a ball bearing which comprises spherical rolling members (c₁, c₂ . . . ) as rolling members, and that the shaft (11) comprises separate bearings (15a₁, 15a₂) which receive the radial forces produced when the gear wheels (12 and 13) are in tooth contact, and which bearings are on both sides of the gear wheel (12).

7. A measuring apparatus as claimed in claim 1, wherein the rod (20) is disposed at one end of the shaft (11) and centrally with respect to the shat (11) and preferably substantially at the same centre line, so that the longitudinal axis (X₁) of the rod is at the centre line (X) of the shaft (11) and the longitudinal axis (X₁) of the road (20) is thus substantially parallel to the shaft (11).

8. A measuring apparatus as claimed in claim 1, wherein the rod (20) is attached at its ends to end pieces (21, 24), of which one end piece (21) is located in the vicinity of the bearing (17) and is connected with the bearing (17), and of which the other end piece (24) is attached to the gear housing (100).

9. A measuring apparatus as claimed in claim 1, wherein the rod (20) is articulated at its both ends with end pieces (21, 24) associated with the ends, the rod (20) being non-rotating, and that said end articulation allows the axial force (F₁ or F₂) to be transmitted as pure to the rod (20) and further to the sensor (25).

10. A measuring apparatus as claimed in claim 1, wherein the ends of the rod (20) are made curved or spherical, and that they form an articulated joint with the end pieces (21, 24) associated with the ends.

11. A measuring apparatus as claimed in claim 1, wherein the rod (20) is attached at its end to an end piece (21, 24) by means of an attachment part (27, 28).

12. A measuring apparatus as claimed in claim 1, wherein the end piece (24) is attached at its end the housing (100) of the gear (10) by means of an attachment part (28) and a cover (102).

13. A measuring apparatus as claimed in claim 1, further comprising a line (e) from the sensor (25) to a central unit (50) for transmitting information from the sensor (25), which central unit (50) determines, based on the information received from the sensor, the magnitude of the axial force (F₁ or F₂) applied to the shaft (11), and that the central unit (50) also observes the direction of the axial force (F₁ or F₂) based on the information transmitted from the sensor (25).

14. A measuring apparatus as claimed in claim 1, wherein the sensor (25) is disposed in the rod (20).

15. A measuring apparatus as claimed in claim 1, wherein the sensor (25) is disposed in an end piece (24) associated with the gear (10).

16. A measuring apparatus as claimed in claim 1, wherein the sensor (25) is disposed in a separate end piece (21), which is connected, on the one hand, to the rod (20) and, on the other hand, to the inner race (22) of the bearing (17).

17. A measuring apparatus as claimed in claim 1, wherein the sensor (25) is a strain gauge.

18. A measuring apparatus as claimed in claim 1, wherein the measuring apparatus (200) for measuring the axial force (F₁ or F₂) either in a clockwise direction of rotation or in a counterclockwise direction of rotation of the shaft (11) is located at one end of the shaft (11).

19. A measuring apparatus as claimed in claim 1, wherein the measuring apparatus (200) and the same sensor (25) thereof observe the magnitude of the axial force (F₁ or F₂) and the direction of the axial force (F₁ or F₂).
